(19) United States
(12) Patent Application Publication
(10) Pub. No.: US 2011/0154335 A1
(43) Pub. Date: Jun. 23, 2011

(54) Content Associated Tasks With Automated Completion Detection

(75) Inventor: Antti-Pekka Tuovinen, Espoo (FI)

(73) Assignee: Nokia Corporation, Espoo (FI)

(21) Appl. No.: 12/644,537

(22) Filed: Dec. 22, 2009

(51) Int. Cl. G06F 9/46

(52) U.S. Cl. 718/100

(57) ABSTRACT

An apparatus for scheduling a task with associated stored defining at least one relevant characteristic is provided. A detected content which defines at least one detected characteristic may be detected and then compared to the relevant characteristic of the stored content in the form of a similarity factor. It may then be determined whether the task has been completed based at least in part on the similarity factor. Information relating to the status of the task may be shared with other devices. A corresponding method and computer program product are also provided.

### TECHNOLOGICAL FIELD

Embodiments of the present invention relate generally to scheduling tasks and, more particularly, relate to systems, methods, and apparatuses for associating stored content with tasks and automatically determining completion of the tasks.

### BACKGROUND OF THE INVENTION

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Along with recent developments in networking there have also been technological advances in scheduling which have sought to allow users to record tasks in the form of appointments and to-do items. Accordingly a user may be able to electronically organize his time and activities. However, the ability of present electronic scheduling systems to provide users with organizational benefits is limited by the manual entry requirements associated with present systems. In this regard, the effort involved in using present scheduling systems may discourage users from taking full advantage of these systems. Accordingly, more user-friendly scheduling systems, methods, and apparatuses may be desirable.

### BRIEF SUMMARY OF THE INVENTION

A method and apparatus are therefore provided that may enable the provision of improved scheduling. In this regard, for example, some embodiments of the present invention may provide for scheduling a task, associating stored content with the task, and determining whether the task has been completed.

In an exemplary embodiment an apparatus comprises at least one processor and at least one memory including computer program code, the at least one memory and the computer program code configured to, with the processor, cause the apparatus to at least perform scheduling a task; associating the task with a stored content defining at least one relevant characteristic; detecting a detected content defining at least one detected characteristic; and determining whether the task has been completed based at least in part on a similarity factor that compares the detected characteristic to the relevant characteristic. The computer program code may cause the apparatus to calculate the similarity factor, or the computer program code may cause the apparatus to receive the similarity factor, such that the similarity factor is not calculated by the apparatus. The program code may cause the apparatus to request user confirmation of completion of the task after determining the task has been completed. Further, the stored content may be stored in the memory, or stored externally to the apparatus. In some embodiments the relevant characteristics may comprise a product identification code and/or a location.

In an additional exemplary embodiment, a method comprises scheduling a task; associating the task with a stored content defining at least one relevant characteristic; detecting a detected content defining at least one detected characteristic; and determining whether the task has been completed based at least in part on a similarity factor that compares the detected characteristic to the relevant characteristic. The method may further comprise calculating the similarity factor or receiving the similarity factor, such as from an external computer. In addition, the method may comprise requesting user confirmation of completion of the task after determining the task has been completed. In some embodiments the relevant characteristics may comprise a product identification code and/or a location.

In a further exemplary embodiment a computer program product comprises at least one computer-readable storage medium having computer-executable program code portions stored therein. The computer-executable program code portions comprise program code instructions for scheduling a task; program code instructions for associating the task with a stored content defining at least one relevant characteristic; program code instructions for detecting a detected content defining at least one detected characteristic; and program code instructions for determining whether the task has been completed based at least in part on a similarity factor that compares the detected characteristic to the relevant characteristic. The computer program product may further comprise program code instructions for calculating the similarity factor or for receiving the similarity factor. The computer program product may additionally comprise program code instructions for requesting user confirmation of completion of the task after determining the task has been completed. In some embodiments the relevant characteristics may comprise a product identification code and/or a location.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates one example of a communication system according to an exemplary embodiment of the present invention;

FIG. 2 illustrates a schematic block diagram of an apparatus for scheduling and determining completion of tasks according to an exemplary embodiment of the present invention;

FIG. 3 illustrates a flowchart of a method of scheduling and determining completion of tasks in accordance with an exemplary embodiment of the present invention;

FIG. 4 illustrates a task and associated stored content in accordance with an exemplary embodiment of the present invention;

FIG. 5 illustrates detected content in accordance with an exemplary embodiment of the present invention; and

FIG. 6 illustrates calculation of a similarity factor in accordance with an exemplary embodiment of the present invention.

### DETAILED DESCRIPTION OF THE INVENTION

Some embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information” and similar terms may be used interchangeably to refer to data capable of being transmitted, received and/or stored in accordance with embodiments of the present invention. Moreover, the term “exemplary”, as used herein, is not provided to convey any qualitative assessment, but instead merely to convey an illustration of an example. Thus, use of any such terms should not be taken to limit the spirit and scope of embodiments of the present invention.

As used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

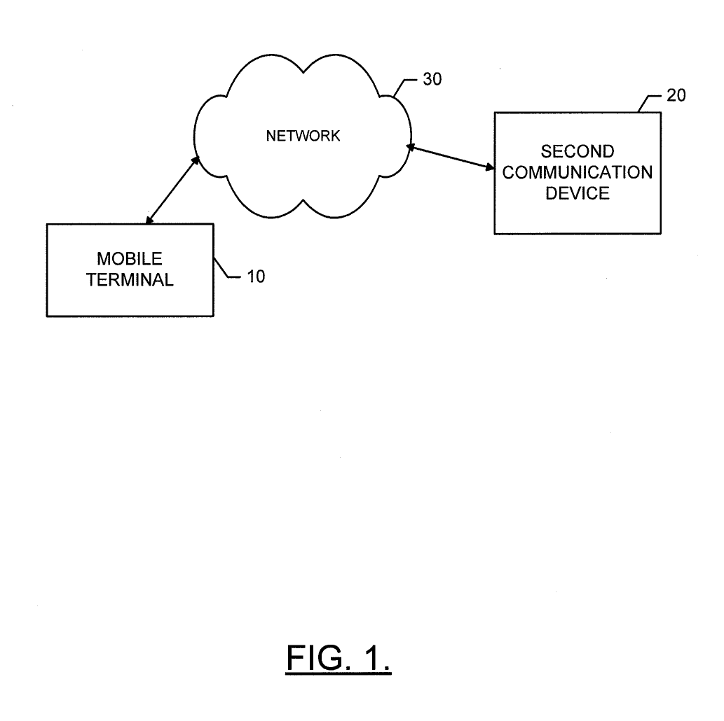

FIG. 1 illustrates a generic system diagram in which a device such as a mobile terminal 10, which may benefit from embodiments of the present invention, is shown in an exemplary communication environment. In this regard, the mobile terminal 10 may be configured to schedule a task with associated stored content and determine completion of the task in accordance with an exemplary embodiment. As shown in FIG. 1, an embodiment of a system in accordance with an example embodiment of the present invention may include a first communication device (e.g., mobile terminal 10) and a second communication device 20 capable of communication with each other. In an exemplary embodiment, the mobile terminal 10 and the second communication device 20 may be in communication with each other via a network 30. In some cases, embodiments of the present invention may further include one or more network devices with which the mobile terminal 10 and/or the second communication device 20 may communicate to provide, request and/or receive information. The network devices may include, for example, one or more servers, base stations, access points, gateways, communication controllers or other computers configured to perform various functions. In some cases, embodiments of the present invention may also or alternatively be practiced on one or more of the network devices.

It should be noted that although FIG. 1 shows a communication environment that may support client/server application execution, in some embodiments, the mobile terminal 10 and/or the second communication device 20 may employ embodiments of the present invention without any network communication, but instead via a direct communication link between the mobile terminal 10 and the second communication device 20. As such, for example, applications executed locally at the mobile terminal 10 and served to the second communication device 20 via a direct wired or wireless link may also benefit from embodiments of the present invention. However, it should be noted that communication techniques such as those described herein can be used not only in embedded devices, but in desktops and servers as well.

The network 30, if employed, may include a collection of various different nodes, devices or functions that may be in communication with each other via corresponding wired and/or wireless interfaces. As such, the illustration of FIG. 1 should be understood to be an example of a broad view of certain elements of the system and not an all inclusive or detailed view of the system or the network 30. One or more communication terminals such as the mobile terminal 10 and the second communication device 20 may be in communication with each other via the network 30 or via device to device (D2D) communication and each may include an antenna or antennas for transmitting signals to and for receiving signals from a base site, which could be, for example a base station that is a part of one or more cellular or mobile networks or an access point that may be coupled to a data network, such as a local area network (LAN), a metropolitan area network (MAN), and/or a wide area network (WAN), such as the Internet. In turn, other devices such as processing elements (e.g., personal computers, server computers or the like) may be coupled to the mobile terminal 10 and/or the second communication device 20 via the network 30. By directly or indirectly connecting the mobile terminal 10 and/or the second communication device 20 and other devices to the network 30 or to each other, the mobile terminal 10 and/or the second communication device 20 may be enabled to communicate with the other devices or each other, for example, according to numerous communication protocols including Hypertext Transfer Protocol (HTTP) and/or the like, to thereby carry out various communication or other functions of the mobile terminal 10 and the second communication device 20, respectively.

Furthermore, although not specifically shown in FIG. 1, the mobile terminal 10 and the second communication device 20 may communicate in accordance with, for example, radio frequency (RF), Bluetooth (BT), Infrared (IR) or any of a number of different wireline or wireless communication techniques, including LAN, wireless LAN (WLAN), Worldwide Interoperability for Microwave Access (WiMAX), WiFi, ultra-wide band (UWB), Wibree techniques and/or the like. As such, the mobile terminal 10 and the second communication device 20 may be enabled to communicate with the network 30 and each other by any of numerous different access mechanisms. For example, mobile access mechanisms such as wideband code division multiple access (W-CDMA), CDMA2000, global system for mobile communications (GSM), LTE, general packet radio service (GPRS) and/or the like may be supported as well as wireless access mechanisms such as WLAN, WiMAX, and/or the like and fixed access mechanisms such as digital subscriber line (DSL), cable modems, Ethernet and/or the like.

In example embodiments, the first communication device (e.g., the mobile terminal 10) may be a mobile communication device such as, for example, a personal digital assistant (PDA), wireless telephone, mobile computing device, camera, video recorder, audio/video player, positioning device (e.g., global positioning system (GPS)), game device, television device, radio device, or various other like devices or combinations thereof. The second communication device 20 may also be a mobile terminal such as those listed above or other mobile or embedded devices, but could also be a fixed communication device in some instances. As such, the mobile terminal 10, network device and/or the second communication device 20 may include, for example, processing circuitry that may include a processor and memory for storing instructions that are executable by the processor in order to cause the mobile terminal 10, network device and/or the second communication device 20, respectively, to perform corresponding operations that are defined by the instructions. In some cases, the processor of the mobile terminal 10, network device and/or the second communication device 20 may be embodied as, include, or otherwise control processing hardware such as one or more application specific integrated circuits (ASICs) that are configured to provide a corresponding specific functionality.

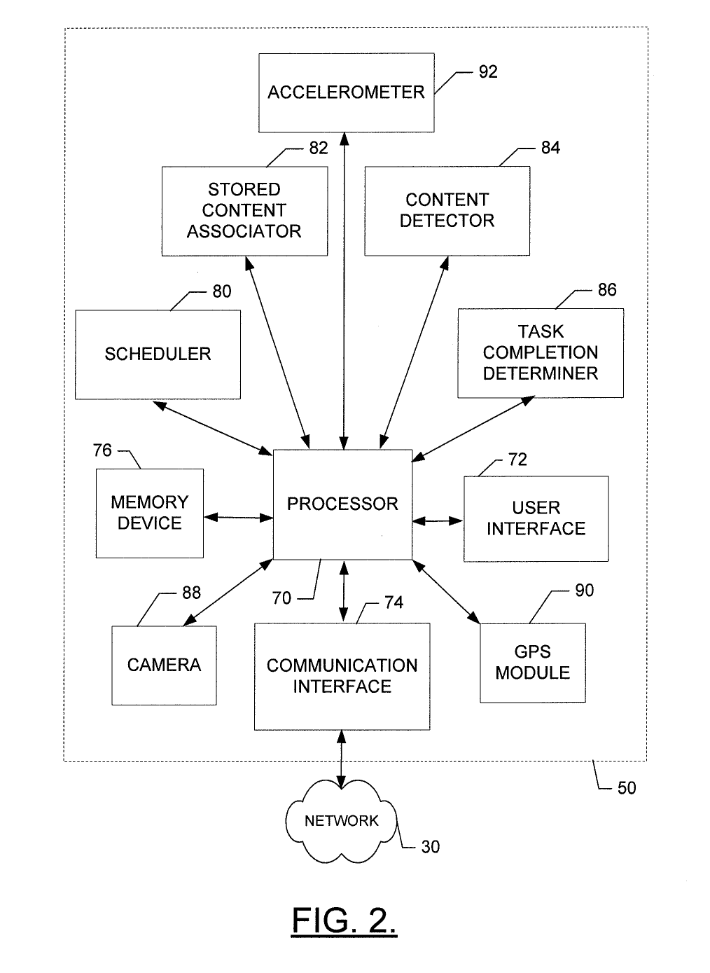

In an exemplary embodiment, the mobile terminal 10 may be configured to include or otherwise employ an apparatus according to an exemplary embodiment of the present invention. FIG. 2 illustrates a schematic block diagram of an apparatus for scheduling a task with associated stored content and determining completion of the task in accordance with an exemplary embodiment of the present invention. An exemplary embodiment of the invention will now be described with reference to FIG. 2, in which certain elements of an apparatus 50 for scheduling a task with associated stored content and determining completion of the task are displayed. The apparatus 50 of FIG. 2 may be employed, for example, on a communication device (e.g., the mobile terminal 10) or a variety of other devices, such as, for example, any of the network or other devices listed above. However, it should be noted that the components, devices or elements described below may not be mandatory and thus some may be omitted in certain embodiments. For example, while embodiments of the apparatus 50 will generally be described in terms of use in the mobile terminal 10, it should be understood that the apparatus may be used in other devices. In this regard, the mobile terminal 10 will generally be described as being in communication with a network 30. While the network 30 may provide additional functionality, it is not necessary in all embodiments of the invention. Accordingly, the apparatus 50 need not necessarily be linked to a network to benefit from the present disclosure. Additionally, although the network 30 is generally described as being in communication with a second communication device 20 through the network 30, this too may be optional. However, such a configuration may provide additional functionality, as will be described below. Further, the apparatus 50 does not necessarily need to be mobile. For example, a desktop personal computer may benefit from embodiments of the present invention. Accordingly, the description relating to the mobile terminal 10 should be considered exemplary, with other uses of the apparatus 50 falling within the scope of other embodiments of the invention. Additionally, some embodiments of apparatuses may include further components, devices or elements beyond those shown and described herein.

Referring now to FIG. 2, the apparatus 50 may include or otherwise be in communication with a processor 70, a user interface 72, a communication interface 74 and a memory device 76. The memory device 76 may include, for example, one or more volatile and/or non-volatile memories. In other words, for example, the memory device 76 may be an electronic storage device comprising gates configured to store data (e.g., bits) that may be retrievable by a machine (e.g., a computing device). The memory device 76 may be configured to store information, data, applications, instructions or the like for enabling the apparatus to carry out various functions in accordance with exemplary embodiments of the present invention. For example, the memory device 76 could be configured to buffer input data for processing by the processor 70. Additionally or alternatively, the memory device 76 could be configured to store instructions for execution by the processor 70.

The processor 70 may be embodied in a number of different ways. For example, the processor 70 may be embodied as one or more of various processing means such as a coprocessor, a microprocessor, a controller, a digital signal processor (DSP), processing circuitry with or without an accompanying DSP, or various other processing devices including integrated circuits such as, for example, an ASIC (application specific integrated circuit), an FPGA (field programmable gate array), a hardware accelerator, a special-purpose computer chip, or the like. In an exemplary embodiment, the processor 70 may be configured to execute instructions stored in the memory device 76 or otherwise accessible to the processor 70. Alternatively or additionally, the processor 70 may be configured to execute hard coded functionality. As such, whether configured by hardware or software methods, or by a combination thereof, the processor 70 may represent an entity (e.g., physically embodied in circuitry) capable of performing operations according to embodiments of the present invention while configured accordingly. Thus, for example, when the processor 70 is embodied as an ASIC, FPGA or the like, the processor 70 may be specifically configured hardware for conducting the operations described herein. Alternatively, as another example, when the processor 70 is embodied as an executor of software instructions, the instructions may specifically configure the processor 70 to perform the algorithms and/or operations described herein when the instructions are executed. However, in some cases, the processor 70 may be a processor of a specific device (e.g., a mobile terminal or network device) adapted for employing embodiments of the present invention by further configuration of the processor 70 by instructions for performing the algorithms and/or operations described herein. The processor 70 may include, among other things, a clock, an arithmetic logic unit (ALU) and logic gates configured to support operation of the processor 70.

Meanwhile, the communication interface 74 may be any means such as a device or circuitry embodied in either hardware, a computer program product, or a combination of hardware and software that is configured to receive and/or transmit data from/to a network and/or any other device or module in communication with the apparatus. In this regard, the communication interface 74 may include, for example, an antenna (or multiple antennas) and supporting hardware and/or software for enabling communications with a wireless communication network. In some environments, the communication interface 74 may alternatively or also support wired communication. As such, for example, the communication interface 74 may include a communication modem and/or other hardware/software for supporting communication via cable, digital subscriber line (DSL), universal serial bus (USB) or other mechanisms.

The apparatus 50 may further comprise a camera 88 in communication with the processor 70. The camera 88 may be configured to capture digital photographs which may be stored in the memory device 76 or externally to the apparatus 50, such as through the communication interface 74 to the network 30. Additionally, the apparatus 50 may comprise a Global Positioning System (GPS) module 90 in communication with the processor 70. The GPS module 90 may be used to determine the location of the apparatus 50. The location information provided by the GPS module 90 may then be used in combination with map data, which may be stored, for example, in the memory device 76 or accessed from the network 30 to provide navigational services and other location related services and functions. The relevant processing functions associated with the location related services and functions may be conducted within the apparatus 50, such as by the processor 70, or externally to the apparatus such as by a computing device linked to the apparatus 50 through the network 30. The location information provided by the GPS module 90 may also be used in conjunction with location information obtained from or calculated based on wireless networks to increase accuracy and/or speed in determining position of the apparatus 50. An accelerometer 92 in communication with the processor 70 may further be provided in the apparatus 50, and may assist in determining the orientation and position of the apparatus.

The user interface 72 may be in communication with the processor 70 to receive an indication of a user input at the user interface 72 and/or to provide an audible, visual, mechanical or other output to the user. As such, the user interface 72 may include, for example, a keyboard, a mouse, a joystick, a display, a touch screen, soft keys, a microphone, a speaker, or other input/output mechanisms. In an exemplary embodiment in which the apparatus is embodied as a server or some other network devices, the user interface 72 may be limited, or eliminated. However, in an embodiment in which the apparatus is embodied as a communication device (e.g., the mobile terminal 10), the user interface 72 may include, among other devices or elements, any or all of a speaker, a microphone, a display, and a keyboard or the like. In this regard, for example, the processor 70 may comprise user interface circuitry configured to control at least some functions of one or more elements of the user interface, such as, for example, a speaker, ringer, microphone, display, and/or the like. The processor 70 and/or user interface circuitry comprising the processor 70 may be configured to control one or more functions of one or more elements of the user interface through computer program instructions (e.g., software and/or firmware) stored on a memory accessible to the processor 70 (e.g., memory device 76, and/or the like).

In an exemplary embodiment, the processor 70 may be embodied as, include or otherwise control a scheduler 80, a stored content associator 82, a content detector 84, and a task completion determiner 86 to schedule a task with associated stored content and determine completion of the task. The scheduler 80, stored content associator 82, content detector 84, and task completion determiner 86 may each be any means such as a device or circuitry operating in accordance with a computer program product or otherwise embodied in hardware or a combination of hardware and software (e.g., processor 70 operating under software control, the processor 70 embodied as an ASIC or FPGA specifically configured to perform the operations described herein, or a combination thereof) thereby configuring the device or circuitry to perform the corresponding functions of the scheduler, stored content associator, content detector, and task completion determiner as described herein. Thus, in examples in which software is employed, a device or circuitry (e.g., the processor 70 in one example) executing the software forms the structure associated with such means.

The scheduler 80, stored content associator 82, content detector 84, and task completion determiner 86 will now be briefly described, with additional description and examples recited below. The scheduler 80 may be configured to schedule a task. A task, which may alternatively be referred to as a “to-do” item, is an event requiring activity to complete it. Thus, the scheduler 80 may record the event requiring completion and a relevant window of time or deadline for completing the task, if applicable. The stored content associator 82 may associate stored content, which may be stored in the memory device 76 or stored externally to the apparatus 50 such as on the network 30 accessible through the communication interface 74, with the task scheduled by the scheduler 80. The stored content may define at least one relevant characteristic which may be usable to determine whether the task has been completed, as will be described below. Accordingly, the detector 84 may detect a detected content defining at least one detected characteristic. The task completion determiner 86 may then determine whether the task has been completed based at least in part on a similarity factor that compares the detected characteristic of the detected content to the relevant characteristic of the stored content. The similarity factor may be calculated by the apparatus 50, or the apparatus can receive the similarity factor from an external source such as from a device communicating with the network 30 accessible through the communication interface 74. Further, the apparatus 50 may request user confirmation of completion of the task after the task completion determiner 86 determines that the task has been completed.

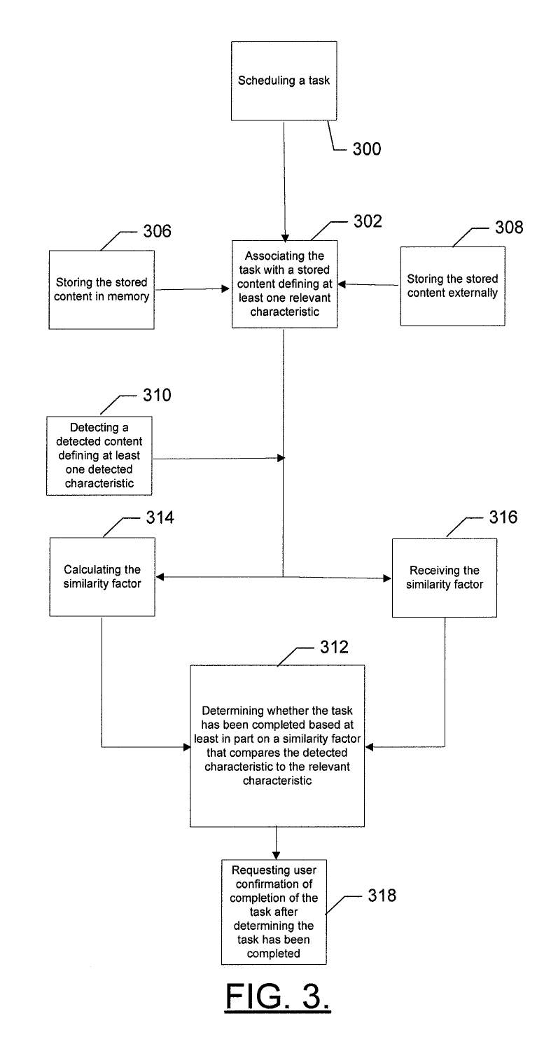

In terms of methods associated with embodiments of the present invention, the above described apparatus or other embodiments of apparatuses may be employed. In this regard, FIG. 3 is a flowchart of a system, method and program product according to exemplary embodiments of the invention. It will be understood that each block of the flowcharts, and combinations of blocks in the flowcharts, may be implemented by various means, such as hardware, firmware, processor, circuitry and/or other device associated with execution of software including one or more computer program instructions. For example, one or more of the procedures described above may be embodied by a computer program product including computer program instructions. In this regard, the computer program instructions which embody the procedures described above may be stored by a memory device of an apparatus employing an embodiment of the present invention and executed by a processor of the apparatus. As will be appreciated, any such computer program instructions may be loaded onto a computer or other programmable apparatus (e.g., hardware) to produce a machine, such that the resulting computer or other programmable apparatus embody means for implementing the functions specified in the flowchart block(s). These computer program instructions may also be stored in a computer-readable memory that may direct a computer or other programmable apparatus to function in a particular manner, such that the instructions stored in the computer-readable memory produce an article of manufacture the execution of which implements the function specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s).

Accordingly, blocks of the flowcharts support combinations of means for performing the specified functions and program instruction means for performing the specified functions. It will also be understood that one or more blocks of the flowchart, and combinations of blocks in the flowcharts, can be implemented by special purpose hardware-based computer systems which perform the specified functions, or combinations of special purpose hardware and computer instructions.

In this regard, one embodiment of a method according to an exemplary embodiment, as shown in FIG. 3 includes scheduling a task at operation 300, such as through using the scheduler 80. Scheduling a task may include recording an activity requiring completion by a certain deadline. The method further includes associating the task with a stored content defining at least one relevant characteristic at operation 302, which may be conducted by the stored content associator 82. The operation 300 of scheduling a task and the operation 302 of associating the task with stored content may occur substantially simultaneously. In other embodiments the scheduling the task operation 300 may occur before the associating the task with stored content operation 302. The stored content may be stored in internal memory as indicated at block 306 such as the memory device 76 when using the apparatus 50 to complete the method. Alternatively, the stored content may be stored externally, as indicated at block 308.

The method further includes detecting a detected content defining at least one detected characteristic at operation 310, which may be conducted by the content detector 84. Thereafter the method further includes determining whether the task has been completed based at least in part on a similarity factor that compares the detected characteristic of the detected content to the relevant characteristic of the stored content at operation 312. The method may include calculating the similarity factor at operation 314 or receiving the similarity factor at operation 316. Thus, the task completion determiner 86, for example, may calculate the similarity factor, or receive the similarity factor from an external source which calculates it. Thus, by way of example, the similarity factor may be calculated by an external computing device and then transmitted to the apparatus 50 through the network 30. In such embodiments at least one relevant characteristic of the stored content and at least one detected characteristic of the detected content will be made available to the external computing device, such as by transmission through the network 30. As an alternative, the entirety of the stored content and/or the detected content may be accessible to the external computing device. In this case the external computing device may analyze the stored content and/or detected content to determine their relevant characteristic and detected characteristic, respectively. Examples of relevant characteristics and detected characteristics as they relate to stored content and detected content will be described below. Regardless of how the operation 312 of determining whether the task has been completed is conducted, the method may further comprise requesting user confirmation of completion of the task after determining the task has been completed at operation 318. The operation 318 of requesting user confirmation may function to remove any uncertainty associated with the operation 312 of determining whether the task has been completed.

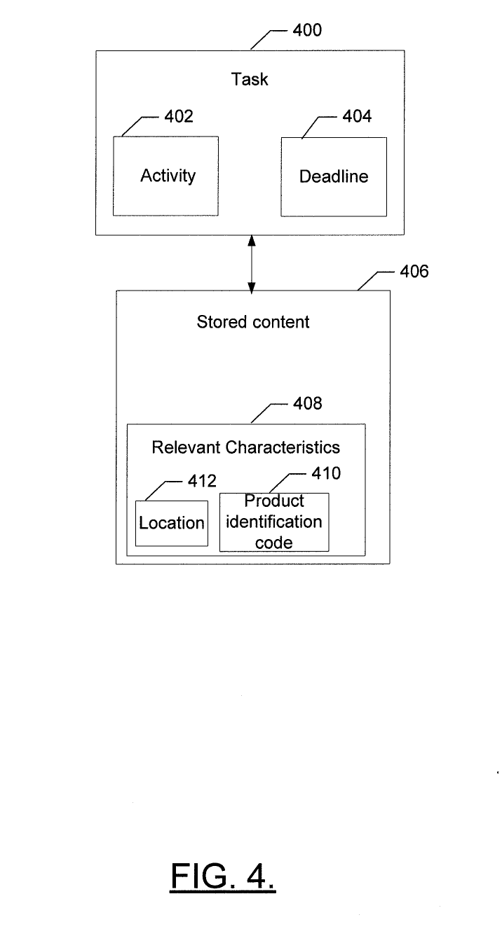

FIG. 4 illustrates a task 400 as it relates to embodiments of the invention. A task may comprise an activity 402 requiring completion and a deadline 404 for completing the activity. Generally, information relating to “who, what, where, and when” may be recorded with a task. As described above, the task 400 may also be associated with a stored content 406 at least one relevant characteristic 408. By way of example, in some embodiments the stored content 406 may comprise a photograph.

Example uses of embodiments of the invention employing the above-described apparatuses and methods will now be described. In a first example embodiment, a user employs the invention to remind him that he needs to purchase a carton of orange juice (the activity 402) today (the deadline 404) and he wants to associate this task 400 with a photo of the carton of orange juice (the stored content 406), and assign the task to himself and his wife. The user may begin by scheduling the task at operation 300 and associating the task with the stored content defining at least one relevant characteristic at operation 302 using the apparatus 50, as may be embodied in the mobile terminal 10. The first step in this process may depend on the particular embodiment of the invention which is employed. The details regarding these various embodiments will be discussed in detail below, but for the time being it is sufficient to note that in some embodiments the user may begin by using the camera 88 to take a photo, selecting a relevant photo already in a gallery application of the apparatus 50, or using a separate application specifically configured to associate stored content to a task.

The purpose of the operation 302 of associating the task with the stored content may vary depending on the particular task. In the present example, the photo could be associated with the task 400 such that it is shown when a reminder for the task is displayed by the user interface 72. This may provide the user with a quick and easy way to remember the activity 402 requiring completion. However, the operation 302 of associating the task with the stored content may provide additional benefits. In particular, the stored content 406 may define at least one relevant characteristic 408. In the case of a carton of orange juice, one of the relevant characteristics 408 may comprise a product identification code 410. A product identification code may comprise a number of different forms, but one common embodiment is that of the Universal Product Code (UPC). The UPC and other types of product identification codes 410 are often printed in barcode format. Therefore, the apparatus 50 may include a barcode scanning application for this purpose. Alternatively or additionally, the apparatus 50 may include an Optical Character Recognition (OCR) application. Accordingly, the apparatus 50 may record the product identification code 410 as a relevant characteristic 408 which is associated with the task 400 as part of the stored content 406. One way of retaining the product identification code 410 is to embed it as metadata in the photo. Although the identification and storage of the relevant characteristic 408 was described above as being conducted by the apparatus 50, this activity may be conducted by an external computer. In particular, the apparatus 50 may transmit the stored content 406 through the network 30 to an external computer which may review the photo for a product identification code 410, and other information. Further, the apparatus 50 may associate multiple pieces of stored content 406 with the task 400. In this regard, the apparatus may include logic configured to recognize that photos of multiple products should be associated with the same task 400 when the products can each be purchased at a single store, and accordingly the operation 302 of associating the task with the stored content may do this automatically.

When the user sets a deadline 404 for the task 400, the apparatus 50 may be configured to provide the user with a reminder. As described above, the reminder may provide the user with the stored content 406, which in this case comprises the photo. Upon receiving the reminder, the user may attempt to carry out the activity 402 involved with the task 400. Thus, when the user goes to the store, the apparatus 50 may determine that the user has entered a store using location information from the GPS module 90. However, as there may be limitations with respect to the functionality of the GPS module 90 while indoors, other positioning methods can be used in such circumstances. For example, triangulation based on wi-fi base stations' locations, or other known indoor navigation and positioning methods may used, which may utilize the communication interface 74. Once the apparatus 50 recognizes that the user is in the store, the user may then be prompted by the apparatus to manually indicate which items are being purchased, such as by marking the respective activities 402 as “done,” or “complete.”

However, embodiments of the invention automate this process. For example, the apparatus 50 may also include functionality directed to scanning goods for purchase. Thus, in some embodiments the user may take photographs of the items purchased at the store in order to identify product identification codes, which may then be used to determine the total bill when checking out. Thus, the operation 310 of detecting detected content defining at least one detected characteristic is conducted. In other embodiments the apparatus 50 may alternatively or additionally be used to pay for the items purchased using a wireless electronic payment system. In such embodiments the operation 310 of detecting detected content defining at least one detected characteristic may comprise analyzing the electronic receipt for product identification codes. Thus, the operation 310 of detecting detected content may be integrated into other uses of the mobile terminal 10, and the information obtained from this operation may thereafter be employed by the mobile terminal in making a determination of whether the task 400 is completed, as will be described below.

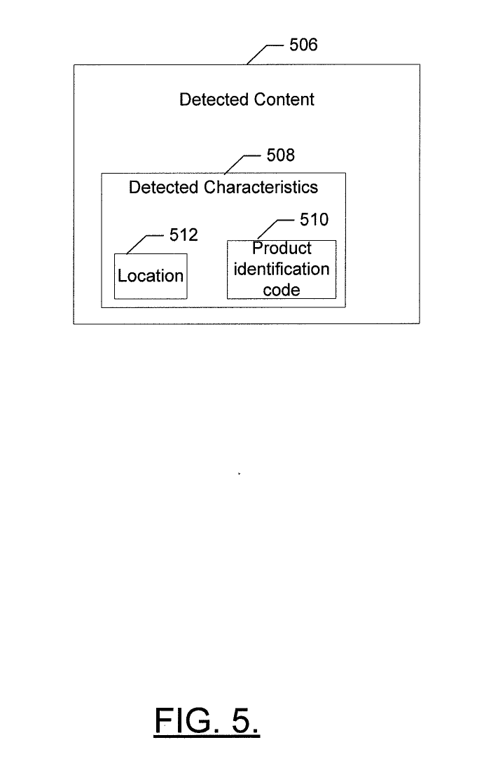

As illustrated in FIG. 5, detected content 506 is similar to stored content. The main difference is that detected content 506 is content which is later detected after the stored content 406 has been associated with the task 400. In the case of taking pictures of items being purchased, the detected content 506 comprises the photographs and the detected characteristics 508 comprise the product identification codes 510 which are recognized from the photographs. In the case of electronic payment without taking pictures, the detected content 506 comprises the electronic receipt, and the detected characteristics 508 comprise the product identification codes 510 which are recognized from the electronic receipt. Similarly as to with the relevant characteristics 408, the operation of isolating the detected characteristics 508 may be conducted within the apparatus 50, or may be conducted externally.

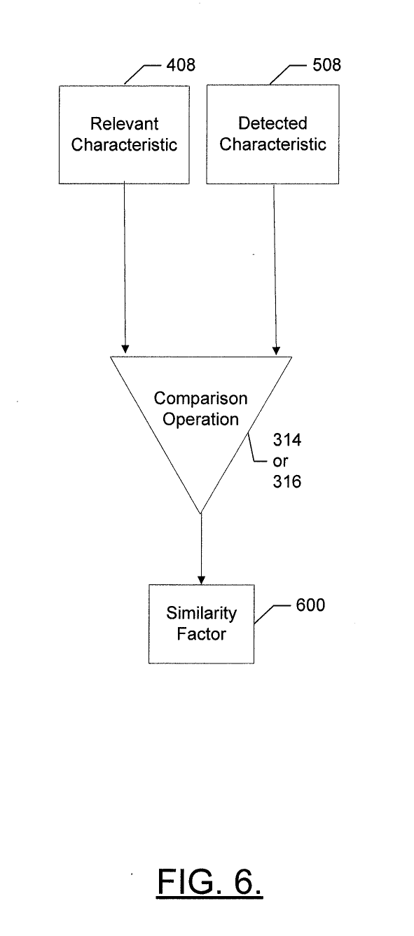

Once the detected characteristics 506 are detected, the operation 314 of calculating the similarity factor or the operation 316 of receiving the similarity factor is conducted, as illustrated in FIG. 6. The operations 314 and 316 represent alternate ways of comparing the relevant characteristics 408 to the detected characteristics 508 which are conducted internally and externally to the apparatus 50, respectively. Therefore, the similarity factor 600 may indicate how closely the relevant characteristic 408 matches the detected characteristic 508. For example when the relevant characteristic 408 is a product identification code 410, the calculation of the similarity factor 600 may involve determining whether or not the product identification code exactly matches the product identification code 510 of the detected content 506. In such instances, the similarity factor 600 may take the form of a Boolean value representing “yes,” or “no” in the form of “1” or “0”, for example.

However, in other embodiments the similarity factor 600 need not necessarily be limited to a Boolean value, and may instead fall in a range of numbers. For example, when the user gets to the store, he may find that a brand of orange juice he normally would not purchase is on sale, making it appealing to him. The user may decide to purchase the more expensive brand of orange juice and thereby takes a photo of this carton, which is analyzed using the operation 310 of detecting a detected content, as described above. In this case, the logic may be intelligent enough to recognize that although the product identification code 510 of the detected content 506 does not match the product identification code 410 of the stored content 406, the product falls within the same category of product, which in this case is orange juice. Therefore, the similarity factor 600 may be set to an intermediate value such as 0.75.

The similarity factor 600 is then used during the operation 312 of determining whether the task has been completed. The apparatus 50 may simply define a threshold value which is required for the task 400 to be deemed completed, such as 0.5, which based on the above example would determine that the task 400 has been completed. Accordingly, embodiments of the invention may conduct the operation 310 of detecting a detected content and the operation 312 of determining whether the task has been completed without requiring additional input from the user beyond that required for other uses of the apparatus 50, such as electronic payment. Therefore, embodiments of the invention provide for increased functionality without unduly burdening the user in order to take advantage of the functionality.

Further, the apparatus 50 may alternatively employ more advanced logic. For example, in one embodiment the operation 312 of determining whether the task has been completed may vary depending on the similarity factor 600 which is calculated. For example, the apparatus 50 may employ logic which automatically determines that a similarity factor 600 which falls below a certain lower threshold (e.g. below 0.5) does not complete the task 400. Additionally, the operation 312 of determining whether the task has been completed may employ logic which preliminarily determines that a task 400 is completed if the similarity factor 600 falls in an intermediate range (e.g. 0.5 to 0.9), but then the apparatus 50 requests user confirmation of completion of the task at operation 318 to ensure that the preliminary determination was correct. However, embodiments of the invention may additionally include logic in the operation 312 of determining whether the task has been completed which defines an upper threshold (e.g. above 0.9) which, when the similarity factor 600 falls above this upper threshold, automatically determines that the task 400 has been completed without conducting the operation 318 of requesting user confirmation of completion of the task. User confirmation may not be necessary in such instances due to the high level of assurance provided by the similarity factor 600. Of course, various forms of logic may be employed in both the calculation of the similarity factor at operation 314 (or external calculation resulting in receipt of the similarity factor at operation 316) and the operation 312 of determining whether the task has been completed, so the upper and lower thresholds described above may vary and are provided solely by way of example. Further, whether or not the operation 318 of requesting user confirmation is conducted may be user specified. For example, in the case of a task 400 that is very important, the user may require that the apparatus 50 conduct the operation 318 of requesting user confirmation to ensure certainty that the task was indeed completed.

The apparatus 50 may also include logic directed to sharing information. For example, as described above, the task 400 may be shared with other users. In this example, the task 400 was shared with the user's wife through the network 30 to her second communication device 20. As the wife is additionally assigned the task 400, she may also be provided with a reminder regarding the activity 402 requiring completion. Therefore, she may go to the store prior to the user in order to complete the task.

An additional example will now be discussed which uses the systems, methods, and apparatuses disclosed herein in a slightly different manner. In this example, the user wants to create a task 400 reminding him to pick up his grandmother (the activity 402) at 7 PM that evening (the deadline 404). After this operation 300 of scheduling the task, the user may conduct the operation 302 of associating the task with a stored content. In this example, this operation 302 may involve linking the task 400 with his grandmother's contact information (the stored content 406) which may be stored in the apparatus 50 in the memory device 76. Later, as the deadline 404 is approaching, the apparatus 50 may provide the user with a reminder regarding the task 400. In some embodiments the reminder may include directions to grandmother's address from the user's current position using location information from the GPS module 90 or other location information sources as described above. Here, the location 412 of grandmother's address is a relevant characteristic 408 of grandmother's contact information (the stored content 406).

After receiving the reminder, the user may travel to grandmother's house (location 412) to pick up grandmother. The apparatus 50 may then conduct the operation 310 of detecting a detected content. For example, the apparatus 50 may attempt to determine the user's present location 512, which is a detected characteristic 508 of the detected content 506. Either of the comparison operations 314, 316 may then be used to determine a similarity factor 600. Thus, the user's present location 512 may be compared to the grandmother's address 412 stored in the apparatus 50. In additional embodiments the location of grandmother's mobile phone, which may comprise the previously discussed second communication device 20, could be compared with the user's location 512. Thus, the comparison operation 314, 316 may comprise comparing the longitudinal and latitudinal data between the location 412 and the user's present location 512. Thus, the similarity factor 600 in this embodiment may reflect a distance between the user's location and the grandmother's location.

Additionally or alternatively, the apparatus could use other information to complete the comparison operation 314, 316. For example, the user's apparatus 50 could attempt to establish a Bluetooth connection with grandmother's phone. In such embodiments the relevant characteristic 408 may comprise the Bluetooth ID of grandmother's phone, and the detected characteristic 508 may comprise the Bluetooth IDs visible to the apparatus 50. In such embodiments, the similarity factor 600 may be a Boolean value which reflects whether or not grandmother's phone is visible through Bluetooth. There may not be a need to provide a range of numbers for the similarity factor 600 in this embodiment because Bluetooth communication is typically limited to relatively short distances, and therefore a Bluetooth connection would be indicative of the user being at the approximate location of the grandmother.

In an alternative or additional embodiment, the relevant characteristics 408 may comprise movement data from grandmother's phone, and the detected characteristics 508 may comprise movement data from the apparatus 50, such as from the accelerometer 92. The comparison operation 314, 316 in this embodiment could then compare the movements of the user's apparatus 50 and the grandmother's phone to output a similarity factor 600 which is indicative of whether or not the user and the grandmother are traveling in the same vehicle.

In some embodiments multiple relevant characteristics 408 and multiple corresponding detected characteristics 508 may be employed to calculate the similarity factor at operation 314 (or externally calculate the similarity factor 600 resulting in receipt of the similarity factor at operation 316). For example, the apparatus 50 may be able to more accurately determine whether the task 400 has been completed when it considers multiple sources of information. In such instances, the comparison operations 314, 316 may calculate an intermediate similarity factor for each relevant characteristic 408 and corresponding detected characteristic 508 which are then combined to form the similarity factor 600, such as by calculating a weighted average, for example. In other embodiments, multiple similarity factors 600 may be calculated in the comparison operations 314, 316, with the operation 312 of determining whether the task has been completed taking into account each of these similarity factors instead of making the determination based on a single similarity factor. Regardless of whether the comparison operations 314, 316 output a single similarity factor 600, or the operation 312 of determining whether the task has been completed takes into account multiple similarity factors, various forms of logic may be employed. For instance, in the above example the logic may weight the Bluetooth information more heavily than the GPS and accelerometer information, as this information may in some instances be deemed to be more indicative of proximity with the grandmother. Thus, the various pieces of information useful for determining whether a task 400 has been completed may be weighted according to numerous different approaches, as would be understood by one having skill in the art.

Regardless of the types of relevant characteristics 408 and detected characteristics 508 employed, the method may continue on with the operation 312 of determining whether the task has been completed based at least in part on the similarity factor 600. As before, the operation 318 of requesting user confirmation of completion of the task may also occur in order to ensure that the task 400 has indeed been completed. An indication of completion of the task 400 could then be shared with any other persons/devices with whom the task was shared.

It is of note that in instances wherein the task 400 is assigned to multiple people, there exists the possibility that duplicate efforts could be wasted on the same activity 402. For example, in the orange juice example described above, the user has shared the task with his wife. This can occur by the mobile terminal 10 transmitting the task 400 to a second device which may be used by the wife, such as the second communication device 20, through the network 30. Thus, both the user and the wife may plan to go to the store to buy the orange juice. When one of the user or his wife goes to the store, the respective device may notify the other device of this fact. Thus, the method may further comprise sharing status information relating to the task.

It is of further note that in embodiments in which tasks 400 are shared between multiple users, the operations 300-318 may be shared between the respective devices (e.g. mobile terminal 10 and second communication device 20) used by the users. For example, the mobile terminal 10 could conduct the operation 300 of scheduling a task, and the second communication device 20 could conduct the operation 302 of associating the stored content with the task. This could occur in situations in which the second communication device 20 has stored content 406 which the mobile terminal 10 does not have. In another example, the operation 310 of detecting a detected content may be conducted on the second communication device 20, whereas the operation 300 of scheduling the task and the operation 302 of associating the task with a stored content may have been originally carried out by the mobile terminal 10. Thus, the method may be conducted by a single device, or it may be conducted by multiple devices coordinating with one another. Therefore, multiple users may coordinate with one another to carry out an activity 402 in order to complete a task 400, while avoiding duplicate efforts by sharing information regarding completion of the task.

In an exemplary embodiment, an apparatus for performing the method of FIG. 3 above may comprise a processor (e.g., the processor 70) configured to perform some or each of the operations (300-318) described above. The processor may, for example, be configured to perform the operations (300-318) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 300-318 may comprise, for example, the processor 70, respective ones of the scheduler 80, the stored content associator 82, the content detector 84, and the task completion determiner 86, and/or a device or circuitry for executing instructions or executing an algorithm for processing information as described above.

With further regard to the apparatus 50, the particular implementation of the scheduler 80, stored content associator 82, content detector 84, and task completion determiner 86 as they relate to any other software and hardware of the apparatus may vary. For example, the scheduler 80 and stored content associator 82 may take the form of a handler in a camera or gallery application of the apparatus 50 when the stored content is photo-derived. In such embodiments the content detector 84 and the task completion detector 86 may be built-in to an organizer/calendar in the apparatus 50. Therefore, the user may begin by either using the camera 88 to take a photo, or may select a relevant photo already in the gallery. The association of the stored content 402 to the task 400 by the stored content associator 82 may thus take the form of an option to create a task associated with the photo appearing in the gallery application and/or the camera application.

In an alternate embodiment the scheduler 80, stored content associator 82, content detector 84, and task completion determiner 86 may comprise a separate application or agent for the apparatus 50. In such embodiments the calendar and other relevant applications may share their data with the separate application and allow it to manipulate the data. A further embodiment may comprise a hybrid of the two above-described embodiments. For example, the scheduler 80 and the stored content associator 82 may take the form of a handler in a camera or gallery application of the apparatus 50 as in the first embodiment. However, the content detector 84 and the task completion determiner 86 may comprise a separate application/agent as in the second embodiment.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the invention. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the invention. In this regard, for example, different combinations of elements and/or functions than those explicitly described above are also contemplated within the scope of the invention. Although specific terms are employed herein, they are used in a generic and descriptive sense only and not for purposes of limitation.

That which is claimed:

1. An apparatus comprising at least one processor and at least one memory including computer program code, the at least one memory and the computer program code configured to, with the processor, cause the apparatus to at least perform:
scheduling a task;
associating the task with a stored content defining at least one relevant characteristic;
detecting a detected content defining at least one detected characteristic; and
determining whether the task has been completed based at least in part on a similarity factor that compares the detected characteristic to the relevant characteristic.

2. The apparatus of claim 1, wherein the computer program code causes the apparatus to calculate the similarity factor.

3. The apparatus of claim 1, wherein the computer program code causes the apparatus to receive the similarity factor, such that the similarity factor is not calculated by the apparatus.

4. The apparatus of claim 1, wherein the program code causes the apparatus to request user confirmation of completion of the task after determining the task has been completed.

5. The apparatus of claim 1, wherein the stored content is stored in the memory.

6. The apparatus of claim 1, wherein the stored content is stored externally to the apparatus.

7. The apparatus of claim 1, wherein the relevant characteristic comprises a product identification code.

8. The apparatus of claim 1, wherein the relevant characteristic comprises a location.

9. A method comprising:
scheduling a task;
associating the task with a stored content defining at least one relevant characteristic;
detecting a detected content defining at least one detected characteristic; and
determining whether the task has been completed based at least in part on a similarity factor that compares the detected characteristic to the relevant characteristic.

10. The method of claim 9, further comprising calculating the similarity factor.

11. The method of claim 9, further comprising receiving the similarity factor.

12. The method of claim 9, further comprising requesting user confirmation of completion of the task after determining the task has been completed.

13. The method of claim 9, wherein the relevant characteristic comprises a product identification code.

14. The method of claim 9, wherein the relevant characteristic comprises a location.

15. A computer program product comprising at least one computer-readable storage medium having computer-executable program code portions stored therein, the computer-executable program code portions comprising:
program code instructions for scheduling a task;
program code instructions for associating the task with a stored content defining at least one relevant characteristic;
program code instructions for detecting a detected content defining at least one detected characteristic; and
program code instructions for determining whether the task has been completed based at least in part on a similarity factor that compares the detected characteristic to the relevant characteristic.

16. The computer program product of claim 15, further comprising program code instructions for calculating the similarity factor.

17. The computer program product of claim 15, further comprising program code instructions for receiving the similarity factor.

18. The computer program product of claim 15, further comprising program code instructions for requesting user confirmation of completion of the task after determining the task has been completed.

19. The computer program product of claim 15, wherein the relevant characteristic comprises a product identification code.

20. The computer program product of claim 15, wherein the relevant characteristic comprises a location.
